(19) United States
(12) Patent Application Publication
(10) Pub. No.: US 2006/0212198 A1
(43) Pub. Date: Sep. 21, 2006

(54) Vehicle with a vehicle data network

(76) Inventor: Robert Lueftner, Dorfprozelten (DE)

Correspondence Address: MCGLEW & TUTTLE, PC, P.O. BOX 9227, SCARBOROUGH STATION, SCARBOROUGH, NY, 10510-9227, US

(21) Appl. No.: 11/374,940

(22) Filed: Mar. 14, 2006

(30) Foreign Application Priority Data
Mar. 15, 2005 (DE) 20 2005 004 280.3

(51) Int. Cl. G06F 17/00

(52) U.S. Cl. 701/36; 701/48

(57) ABSTRACT

A vehicle has multiple functional units and a central control, whereby the various functional units and the central control can exchange data via a digital vehicle data network. At least one user data interface (03, 05) is incorporated into the vehicle data network so that digital data can be exchanged between external devices and the vehicle data network in a process controlled by the user.

### CROSS REFERENCE TO RELATED APPLICATIONS

This application claims the benefit of priority under 35 U.S.C. § 119 of German patent application DE 20 2005 004 280.3 filed Mar. 15, 2005, the entire contents of which are incorporated herein by reference.

### FIELD OF THE INVENTION

This invention relates to a vehicle having a vehicle data network and more particularly relates to a vehicle with several functional units and a central control, wherein the different functional units and the central control are able to exchange data via a digital vehicle data network.

### BACKGROUND OF THE INVENTION

In modern vehicles, a central vehicle control is usually provided for exchanging digital data via a vehicle data network with the various functional units in the vehicle, e.g., the air conditioning system, electric windows or exterior rear-view mirrors.

With known vehicles, the vehicle data network is designed as a closed structure. A service computer can be connected to the vehicle data network by suitably trained personnel only for input and/or output of data as part of repairs and maintenance work. The user of the vehicle himself does not have an opportunity to exchange data with the vehicle data network. The known vehicles thus have the disadvantage that the occupants of the vehicle cannot have any access to the functional resources available in the vehicle via data exchange.

### SUMMARY OF THE INVENTION

Against the background of this state of the art, the object of the present invention is therefore to provide a novel vehicle that overcomes the disadvantages of the known state of the art.

According to the invention, a vehicle with several functional units and a central control is provided wherein the different functional units and the central control are able to exchange data via a digital vehicle data network. At least one user data interface is incorporated into the vehicle data network, wherein digital data can be exchanged between external devices and the vehicle data network via this user data interface under the control of a user.

The invention is based on the fundamental idea that at least one user data interface is incorporated into the vehicle data network. Digital data can then be exchanged in a user-controlled operation via the user data interface between the vehicle data network and external devices the user would like to use in the vehicle. For example, it is conceivable for data from external electronic entertainment devices, such as an MP3 player or a CD player, to be input into the vehicle's entertainment system. Furthermore, it is also conceivable for telecommunications devices, e.g., camera phones, to exchange data with the vehicle data network via the user data interface to permit an expanded scope of functions in this way.

Essentially it does not matter how data is exchanged between the external device, e.g., a cell phone, and the user data interface. According to a first preferred embodiment, the user data interface and the external device communicate with one another by wireless data transmission.

Essentially any transmission standard for wireless data transmission may be used. Wireless data communication between the user data interface and an external device can be implemented especially easily and reliably by using the Bluetooth data transmission standard or the WLAN data transmission standard. The known data transmission standards permit the use of standard components that are already available for many applications.

If a vehicle already has a user data interface according to this invention, so that a user can exchange data from external devices with the vehicle data network via the user data interface, it is also possible for this user data interface to be used for individual functional units of the vehicle to likewise exchange data with the user data interface by wireless transmission. In other words, this means that the user data interface is also used for the internal data communication between the functional units in the vehicle and the central control. For example, it is conceivable for the exterior rear-view mirrors on a vehicle to be equipped with suitable sending/receiving units and for the control commands to be transmitted to the exterior rear-view mirrors via the user data interface.

As an alternative to using wireless data communication, the data interface may also be designed as a slot. Exchangeable data storage media, in particular memory sticks or data cards, may then be contacted into this slot to thereby input the data stored on the data storage media into the vehicle network. Approaches for expanding the entertainment system in the vehicle in particular are thus conceivable.

The slot for data exchange with the data storage media should preferably permit data communication according to the USB data transmission standard, i.e., it should be designed in the manner of a USB interface. As a result, the vehicle data network would be made accessible via the USB interface for connection of ultimately any devices, so that all USB-capable devices, e.g., digital cameras or mass memory devices could be incorporated into the vehicle data network. The corresponding technology for data exchange is known from standard commercial computers.

In order for the data interface to be readily accessible for the user, it should preferably be set up in the interior of the vehicle. The arrangement of the data interface in or on a roof console is especially suitable because this space in the overhead area can be reached easily by the driver or the passenger at any time.

As an alternative to this, it is also conceivable for the data interface to be situated in or on the interior rear-view mirror because this functional element must often be installed in the vehicle with cabling, which thus provides easy access to the available vehicle data network without any great additional expense.

To form an interior rear-view mirror which serves as a multifunctional device, a navigation data receiver and/or an evaluation device for evaluating the data stored on the exchangeable data storage media and/or a display device, in particular for display of data received at the data interface and/or a loudspeaker unit and/or a microphone unit may be integrated into the interior rear-view mirror.

An embodiment of the invention is illustrated in the drawing and explained below as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The only Figure is a schematic view from the front of the functional units integrated into an interior rear-view mirror.

### DESCRIPTION OF THE PREFERRED EMBODIMENTS

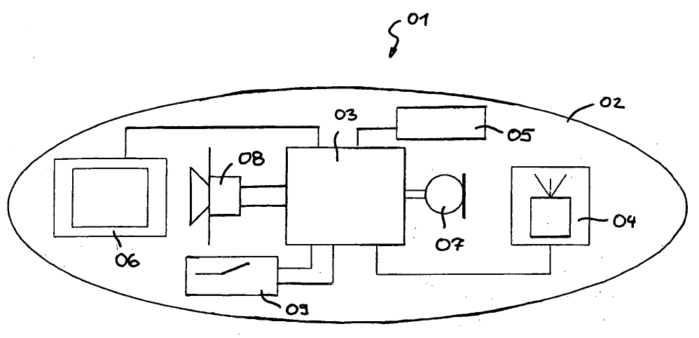

Referring to the drawings in particular, FIG. 1 shows an interior rear-view mirror 01 with a housing 02 and the functional units integrated into the housing 02 shown in schematic form. The mirror element of the interior rear-view mirror 01 is not shown in FIG. 1 and covers the housing 02 toward the front when the interior rearview mirror 01 is installed properly.

The central element of the interior rear-view mirror 01 is an electronic module 03 which is connected to the vehicle data network via corresponding cabling on the one hand while on the other hand allowing wireless data communication with external devices, e.g., cell phones, notebooks, laptops, electronic entertainment devices, navigation devices or other sensors. The wireless data exchange between the electronic module 03 and the external devices (not shown in the Figure) takes place by means of a Bluetooth data transmission standard.

As a result, it is then possible to transmit the data of an onboard and/or offboard navigation system to external terminals or equipment in a stationary installation. Data can also be exchanged with telecommunications devices, especially cell phones, to connect a portable cell phone to the hands-free voice system of the vehicle, for example. Via data exchange with corresponding suitable electronic entertainment devices, e.g., MP3 players or video players, the corresponding entertainment data can be input into the vehicle data network and played back on suitable playback devices such as the sound system or the navigation display, for example.

A navigation data receiver 04 with an integrated antenna is connected to the electronic module 03. In addition, a slot module 05 is connected to the electronic module 03 so that the slot module 05 can also exchange data with the vehicle data network. The slot module 05 serves as the second user data interface into which correspondingly designed data memories, in particular memory sticks, can he inserted and thus linked to the vehicle data network.

In addition, a display device 06 is integrated into the interior rear-view mirrors 01 and connected to the electronic module 03. The display device 06 may be designed in the manner of an LCD display, a TFT display or a DOT matrix. For input and/or output of acoustic signals, a microphone unit 07 and a loudspeaker unit 08 are also integrated into the interior rear-view mirror 01. Switch commands can be generated by means of an operating element 09, e.g., by operating a pushbutton.

While specific embodiments of the invention have been shown and described in detail to illustrate the application of the principles of the invention, it will be understood that the invention may be embodied otherwise without departing from such principles.

What is claimed is:

1. A vehicle with several functional units and a central control, wherein the different functional units and the central control are able to exchange data via a digital vehicle data network, the vehicle further comprising:
at least one user data interface incorporated into the vehicle data network, wherein digital data can be exchanged between external devices and the vehicle data network via said user data interface under the control of a user.

2. The vehicle according to claim 1, wherein data can also be exchanged with the external devices in a wireless fashion via the user data interface.

3. The vehicle according to claim 2, wherein the wireless data communication is realized in accordance with the Bluetooth data transmission standard or the WLAN data transmission standard.

4. The vehicle according to claim 2, wherein data can also be transmitted in a wireless fashion between the central control and at least one functional unit of the vehicle, particularly the exterior rear-view mirrors, via the user data interface.

5. The vehicle according to claim 1, wherein said user data interface is realized in the form of a slot module that can receive removable data storage media including memory sticks or data cards.

6. The vehicle according to claim 5, wherein the slot module makes it possible to realize the data communication in accordance with the USB data transmission standard.

7. The vehicle according to claim 1, wherein the user data interface is arranged in the interior of the vehicle.

8. The vehicle according to claim 7, wherein the user data interface is arranged in or on a roof console.

9. The vehicle according to claim 7, wherein the user data interface is arranged in or on the interior rear-view mirror of the vehicle.

10. The vehicle according to claim 7, further comprising a navigation data receiver integrated into the interior rear-view mirror.

11. The vehicle according to claim 7, further comprising an evaluation device for evaluating the data stored on the exchangeable data storage media, said evaluation device being integrated into the interior rear-view mirror.

12. The vehicle according to one of claim 7, further comprising a display unit for displaying data received via the user data interface, said display unit being integrated into the interior rear-view mirror.

13. The vehicle according to claim 7, further comprising a loudspeaker unit integrated into the interior rearview mirror.

14. The vehicle according to claim 1, further comprising a microphone unit integrated into the interior rearview mirror.

15. A vehicle comprising:
a digital vehicle data network;
a plurality of functional units;
a central control, said functional units and said central control being operatively connected to said digital vehicle data network to exchange data via said digital vehicle data network; and
at least one user data interface operatively connected to said vehicle data network, wherein digital data can be exchanged between external devices and the vehicle data network via said user data interface under the control of a user.

16. The vehicle according to claim 15, wherein said data interface includes a wireless transceiver whereby data is also exchanged with the external devices in a wireless fashion via the user data interface.

17. The vehicle according to claim 15, wherein said digital vehicle data network includes wireless means whereby data is transmitted in a wireless fashion between the central control and at least one of said functional units.

18. The vehicle according to claim 17, wherein said at least one of said functional units comprise exterior mirrors.

19. The vehicle according to claim 15, further comprising:
a navigation data receiver integrated into the interior rear-view mirror;
an evaluation device for evaluating the data stored on the exchangeable data storage media, said evaluation device being integrated into the interior rear-view mirror; and
a display unit for displaying data received via the user data interface, said display unit being integrated into the interior rear-view mirror and wherein the user data interface is arranged in or on the interior rear-view mirror of the vehicle.

20. The vehicle according to claim 15, further comprising:
a loudspeaker unit integrated into the interior rearview mirror; and
a microphone unit integrated into the interior rearview mirror and wherein the user data interface is arranged in or on the interior rear-view mirror of the vehicle.
